(19) United States
(12) Patent Application Publication
(10) Pub. No.: US 2012/0058385 A1
(43) Pub. Date: Mar. 8, 2012

(54) SOLID ELECTROLYTE CELL

(75) Inventors: Reina Ito, Kanagawa (JP); Yuichi Sabi, Tokyo (JP); Yui Senda, Kanagawa (JP)

(73) Assignee: SONY CORPORATION, Tokyo (JP)

(21) Appl. No.: 13/219,041

(22) Filed: Aug. 26, 2011

(30) Foreign Application Priority Data
Sep. 8, 2010 (JP) 2010-200872

(51) Int. Cl. H01M 10/0562; H01M 6/12

(52) U.S. Cl. 429/162; 429/304

(57) ABSTRACT

A solid electrolyte cell includes: a positive electrode side layer; a negative electrode side layer; and a solid electrolyte layer disposed between the positive electrode side layer and the negative electrode side layer, wherein the negative electrode side layer includes a negative electrode side current collector layer; the negative electrode side current collector layer includes a first negative electrode side current collector layer disposed on a side close to the solid electrolyte layer, and a second negative electrode side current collector layer disposed on a side remote from the solid electrolyte layer; the first negative electrode side current collector layer includes copper, nickel, or an alloy containing any of copper and nickel, or stainless steel; and the second negative electrode side current collector layer includes aluminum, silver, or an alloy containing any of aluminum and silver.

### CROSS REFERENCES TO RELATED APPLICATIONS

The present application claims priority to Japanese Priority Patent Application JP 2010-200872 filed in the Japan Patent Office on Sep. 8, 2010, the entire content of which is hereby incorporated by reference.

### BACKGROUND

The present application relates to a solid electrolyte cell. More particularly, the present relates to a solid electrolyte cell such as a thin-film solid lithium secondary cell in which cell component members have thin films.

Lithium secondary cells and batteries such as lithium ion secondary cells and batteries are widely used in portable-type electronic apparatuses and the like, because of their excellent energy density. In general lithium secondary cells and batteries, liquid electrolytes and gel electrolytes are used as electrolyte. In recent years, from the viewpoints of safety and reliability, research and development of all-solid-state lithium secondary cells and batteries in which a solid electrolyte is used in place of a liquid electrolyte have been energetically made.

As a form of the all-solid-state lithium secondary cells and batteries, there have been proposed solid electrolyte batteries in which cell component members such as a positive electrode, a negative electrode, a solid electrolyte, etc. are configured by use of thin films (thin-film solid lithium secondary batteries). (See J. B. Bates et al., “Thin-Film lithium and lithium-ion batteries”, Solid State Ionics, 135, 33-45 (2000) (2. Experimental procedures, 3. Results and discussion).) The thin-film solid lithium secondary battery, characterized by the use of thin films and the attendant miniaturization, can be incorporated onto an electric circuit board on an on-chip basis. In addition, thin-film solid lithium secondary cells or batteries can be incorporated into IC (Integrated Circuit) cards, RF (Radio Frequency) tags and the like.

As a form of the thin-film solid lithium secondary cells and batteries, a lithium-free thin-film battery has been proposed. (See B. J. Neudecker et al., “Lithium-Free Thin-Film Battery with In Situ Plated Li Anode”, J. Electrochem. Soc., 147, 517-523 (2000) (Experimental) (hereinafter referred to as Non-Patent Document 2).) In the Non-patent Document 2, arrangement of a negative electrode on which Li is precipitated has been attempted in a thin-film battery. In this thin-film battery, a negative electrode active material is absent in the initial stage. Instead, Li is precipitated on a negative electrode side current collector during the first run of charging, and the thus precipitated Li functions essentially as a negative electrode active material.

### SUMMARY

In relation to solid electrolyte cells and batteries in which cell component members are configured by use of thinner films, thinning of peripheral members such as current collectors has been proposed for the purpose of obtaining a more enhanced energy density. Thinning of current collectors, however, would be attended by deterioration of charge-discharge cycle characteristics.

Therefore, there is a need for a solid electrolyte cell or battery in which deterioration of cycle characteristics can be restrained.

According to an embodiment, there is provided a solid electrolyte cell including: a positive electrode side layer; a negative electrode side layer; a solid electrolyte layer disposed between the positive electrode side layer and the negative electrode side layer, wherein the negative electrode side layer includes a negative electrode side current collector layer; the negative electrode side current collector layer includes a first negative electrode side current collector layer disposed on a side close to the solid electrolyte layer, and a second negative electrode side current collector layer disposed on a side remote from the solid electrolyte layer; the first negative electrode side current collector layer includes copper, nickel, or an alloy containing any of copper and nickel, or stainless steel; and the second negative electrode side current collector layer includes aluminum, silver, or an alloy containing any of aluminum and silver.

In order to restrain deterioration of cycle characteristics, the solid electrolyte cell according to an embodiment has the following configuration. In the solid electrolyte cell, firstly, the negative electrode side current collector layer includes the first negative electrode side current collector layer disposed on the side close to the solid electrolyte layer, and the second negative electrode side current collector layer disposed on the side remote from the solid electrolyte layer. In addition, the first negative electrode side current collector layer contains copper, nickel, or an alloy containing any of copper and nickel, or stainless steel. Besides, the second negative electrode side current collector layer contains aluminum, silver, or an alloy containing any of aluminum and silver.

According to this solid electrolyte cell configured as above, deterioration of cycle characteristics can be restrained.

Additional features and advantages are described herein, and will be apparent from the following Detailed Description and the figures.

### BRIEF DESCRIPTION OF THE FIGURES

FIG. 1 is a sectional view showing a configuration example of a solid electrolyte cell according to a first embodiment;

FIG. 2 is a sectional view showing a configuration example of a solid electrolyte cell according to a second embodiment;

FIG. 3 is a sectional view showing a configuration example of a solid electrolyte cell according to a third embodiment;

FIG. 4 is a column chart showing measurement results of cycle characteristics;

FIG. 5 is a graph showing measurement results of cycle characteristics;

FIG. 6 is a graph showing measurement results of cycle characteristics; and

FIG. 7 is a graph showing measurement results of cycle characteristics.

### DETAILED DESCRIPTION

Embodiments of the present application will be described below in detail with reference to the drawings.

The description will be made in the following order. Incidentally, in all the drawings concerning the embodiments below, identical or corresponding parts are denoted by the same reference symbols.

1. First Embodiment (First example of solid electrolyte cell)

2. Second Embodiment (Second example of solid electrolyte cell)

3. Third Embodiment (Third example of solid electrolyte cell)

4. Other Embodiments (Modifications)

1. First Embodiment

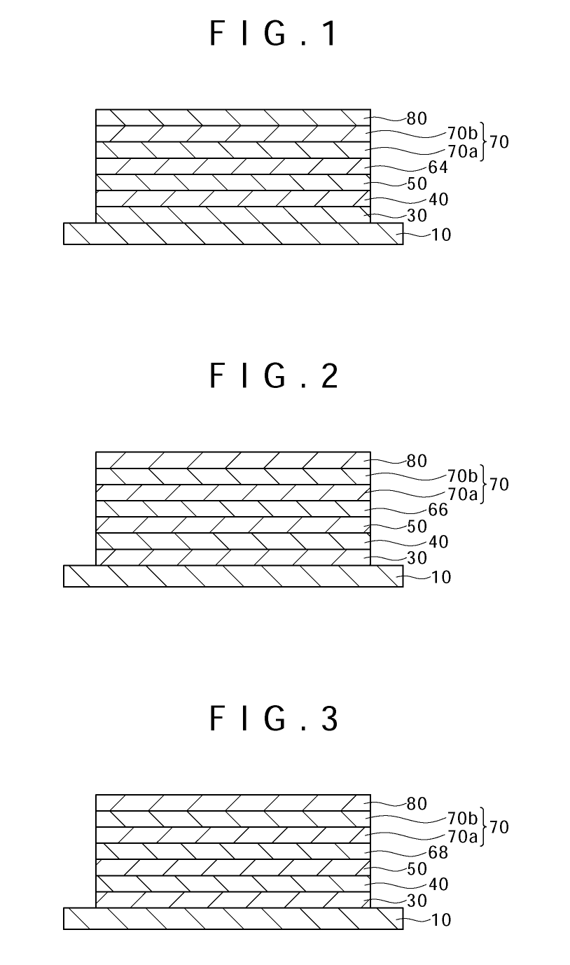

A solid electrolyte cell according to a first embodiment will now be described. FIG. 1 is a sectional view showing a configuration example of the solid electrolyte cell according to the first embodiment. This solid electrolyte cell is, for example, a thin-film type solid electrolyte cell in which cell component members have thin films.

As shown in FIG. 1, this solid electrolyte cell has a structure in which a positive electrode side current collector film 30, a positive electrode side active material film 40, a solid electrolyte film 50, a negative electrode potential forming film 64, a negative electrode side current collector film 70, and a protective film 80 which are layered in this order over a substrate 10.

{Substrate}

As the substrate 10, there can be used, for example, polycarbonate (PC) resin substrates, fluororesin substrates, polyethylene terephthalate (PET) substrates, polybutylene terephthalate (PBT) substrates, polyimide (PI) substrates, polyamide (PA) substrates, polysulfone (PSF) substrates, polyether sulfone (PES) substrates, polyphenylene sulfide (PPS) substrates, polyether-ether ketone (PEEK) substrates, polyethylene naphthalate (PEN) substrates, cycloolefin polymer (COP) substrates, glass substrates, acrylic resin substrates, and the like. The substrate 10 is not specifically restricted, and it suffices for the substrate 10 to be electrically non-conductive and be sufficient in surface smoothness according to the thickness of the cell to be produced. Among the above-mentioned examples of the substrate 10, preferred are the carbonate resin substrates, the glass substrates, and the acrylic resin substrates, from the viewpoints of mass-producibility and cost.

{Positive Electrode Side Current Collector Film}

Examples of the material which can be used as the material constituting the positive electrode side current collector film 30 include Ti, Cu, Ni, and Al. It suffices for the material constituting the positive electrode side current collector film 30 to be electrically conductive and be excellent in durability to repeated charging and discharging.

{Positive Electrode Active Material Film}

It suffices for the material constituting the positive electrode active material film 40 to ensure easy release and occlusion of lithium ions from and into the material so that a large amount of lithium ions can be released from and occluded into the positive electrode active material film 40. Besides, the material is preferably high in potential and low in electrochemical equivalent. Examples of the applicable material include oxides, phosphoric acid compounds and sulfur compounds that contain Li and at least one selected from among Mn, Co, Fe, P, Ni, Si, and Cr. Specific examples of the usable material include lithium-manganese oxides such as LiMnO₂ (lithium manganate), LiMn₂O₄, Li₂Mn₂O₄, etc., lithium-cobalt oxides such as LiCoO₂ (lithium cobaltate), LiCo₂O₄, etc., lithium-nickel oxides such as LiNiO₂ (lithium nickelate), LiNi₂O₄, etc., lithium-manganese-cobalt oxides such as LiMnCoO₄, Li₂MnCoO₄, etc., lithium-titanium oxides such as Li₄Ti₅O₁₂, Liti₂O₄, etc., LiFePO₄ (lithium iron phosphate), titanium sulfide (TiS₂), molybdenum sulfide (MoS₂), iron sulfides (FeS, FeS₂), copper sulfide (CuS), nickel sulfide (Ni₃S₂), bismuth oxide (Bi₂O₃), bismuth plumbate (Bi₂Pb₂O₅), copper oxide (CuO), vanadium oxide (V₆O₁₃), niobium selenide (NbSe₃), etc. Besides, mixtures of two or more of them can also be used. Taking film forming properties, cycle stability of cell and potential into account, preferred are lithium composite oxides which contain Li together with Co or Mn, such as LiCoO₂ and LiMnO₂.

{Solid Electrolyte Film}

As the material constituting the solid electrolyte film 50, there can be used a lithium ion conductor which is in solid state. For example, there can be used those inorganic compounds which have insulating property as well as a high lithium conductivity of not less than 1×10⁻⁶ Scm⁻¹ at normal temperature. Specific examples of the usable material include lithium phosphate (Li₃PO₄),

Li₃PO₄₋ₓNₓ (generally referred to as LiPON) obtained or as if obtained by addition of nitrogen to lithium phosphate (Li₃PO₄), LiBO₂Nₓ, Li₄SiO₄-Li₃PO₄, Li₄SiO₄-Li₃VO₄, etc.

{Negative Electrode Potential Forming Film}

As the material constituting the negative electrode potential forming film 64, there can be used a material which is the same as a positive electrode active material or a material which is close to the positive electrode active material in potential. In this solid electrolyte cell, a negative electrode active material film is not formed at the time of production of the cell, but, instead, the negative electrode potential forming film 64 is formed. A negative electrode active material is produced on the negative electrode side concurrently with charging. Produced on the negative electrode side is Li metal or a layer which contains an excess of Li and which is located at an interface on the negative electrode side of the solid electrolyte film (the layer will hereinafter be referred to as “Li excess layer”).

In this solid electrolyte cell, a high durability to repeated charging and discharging is realized without spoiling charge-discharge characteristics, while utilizing the excessively built-up Li (Li excess layer) as a negative electrode active material.

Thus, the negative electrode potential forming film 64 is a layer for forming a potential when the Li excess layer is lost (in other words, the Li excess layer is again formed at the time of charging after the Li excess layer is lost at the time of discharging). In addition, in the case where the negative electrode potential forming film 64 is formed of a Li-containing material, doping with an excess of Li at the time of charging is limited to a certain level; therefore, there is the merit that deterioration of charging capacity is little. Further, diffusion of Li from the negative electrode potential forming film 64 into the negative electrode side current collector can be suppressed. Consequently, it is possible to restrain deterioration of the current collector and to realize an extremely high repeated charge-discharge characteristics.

{Negative Electrode Side Current Collector Film 70}

The negative electrode side current collector film 70 has a negative electrode inside current collector film 70a and a negative electrode outside current collector film 70b. The negative electrode inside current collector film 70a is disposed on the side close to the solid electrolyte film 50 in the thickness direction, while the negative electrode outside current collector film 70b is disposed on the side remote from the solid electrolyte film 50 in the thickness direction.

{Negative Electrode Inside Current Collector Film 70a}

The material constituting the negative electrode inside current collector film 70a is selected from among materials which are electrically conductive and which would not be easily alloyed with lithium. In addition, as above-mentioned, in this solid electrolyte cell, a negative electrode active material is not formed at the time of manufacture of the cell, but, instead, the Li excess layer is formed by charging and this Li excess layer functions as a negative electrode active material. Therefore, the negative electrode inside current collector film 70a proximate to the Li excess layer is preferably composed of a soft or highly durable material insusceptible to the influences of the formation and losing (extinction or disappearance) of the Li excess layer attendant on the repetition of charging and discharging. Specific examples of such a material include copper, nickel, alloys containing any of copper and nickel, and stainless steel (SUS: Stainless Used Steel).

{Negative Electrode Outside Current Collector Film 70b}

The material constituting the negative electrode outside current collector film 70b is selected from among materials which are low in electric resistance, in order to secure good conductivity. In addition, the negative electrode outside current collector film 70b is exposed to the atmospheric air through the protective film 80, and, therefore, it is preferably formed from a material which is insusceptible to deterioration even when exposed to the atmospheric air. Specific examples of such a material include aluminum, silver, and alloys containing any of aluminum and silver.

The thickness of the negative electrode side current collector film 70 (the thickness of the negative electrode inside current collector film 70a plus the thickness of the negative electrode outside current collector film 70b) is not less than 10 nm, from the viewpoint of thin-film formation. If the thickness of the negative electrode side current collector film 70 is less than 10 nm, thin-film formation itself tends to become difficult to carry out. The upper limit for the thickness of the negative electrode side current collector film 70 is not specifically restricted from the viewpoint of cycle characteristics. However, the thickness is preferably at most 150 nm, more preferably at most 100 nm, from the viewpoints of energy density and tact time.

Incidentally, in the case where the negative electrode side current collector film 70 is composed of a single layer, a decrease in the thickness of the film (or layer) tends to lower the cycle characteristics. On the other hand, in this solid electrolyte cell, the negative electrode side current collector film 70 has the two layers and, further, the layers are each formed through selection of an optimum material. Therefore, even when the negative electrode side current collector film 70 is thinned, it is possible to secure good conductivity and to realize an enhanced durability. As a result, both a prolonged cell life and an increased energy density can be realized.

{Protective Film}

The protective film 80 has an insulating organic matter or an insulating inorganic matter or the like, in order to maintain gas barrier properties. The protective film 80 may be composed of a single layer or composed of a plurality of layers. The protective film 80 may be so provided as to cover entirely the stacked body having the positive electrode side current collector film 30, the positive electrode active material film 40, the solid electrolyte film 50, the negative electrode potential forming film 64, and the negative electrode side current collector film 70 which are stacked over the substrate 10.

{Method of Manufacturing Solid Electrolyte Cell}

The solid electrolyte cell as above-described can be manufactured, for example, as follows. First, the positive electrode side current collector film 30, the positive electrode active material film 40, the solid electrolyte film 50, the negative electrode potential forming film 64, the negative electrode inside current collector film 70a, the negative electrode outside current collector film 70b, and the protective film 80 are sequentially formed over the substrate 10. By this process, the solid electrolyte cell according to the first embodiment can be manufactured. Incidentally, each of the thin films can be formed by appropriately using sputtering, vacuum evaporation, plating, jet coating or the like.

Incidentally, the negative electrode potential forming film 64 may be omitted from the configuration of the solid electrolyte cell as above-described, though the durability to repeated charging and discharging may be lowered. In other words, a configuration of the positive electrode side current collector film 30/positive electrode active material film 40/solid electrolyte film 50/negative electrode inside current collector film 70a/negative electrode outside current collector film 70b/protective film 80 may be adopted. In this case, the first run of charging causes precipitation of Li at the interface between the solid electrolyte film 50 and the negative electrode inside current collector film 70a, and the thus precipitated Li functions as a negative electrode active material in the second and latter runs of charging and discharging.

2. Second Embodiment

A solid electrolyte cell according to a second embodiment will now be described. FIG. 2 is a sectional view showing the configuration of the solid electrolyte cell according to the second embodiment. This solid electrolyte cell is, for example, a thin-film type solid electrolyte cell in which cell component members have thin films.

As shown in FIG. 2, this solid electrolyte cell has a structure in which a positive electrode side current collector film 30, a positive electrode active material film 40, a solid electrolyte film 50, a negative electrode side current collector protection film 66, a negative electrode side current collector film 70, and a protective film 80 are stacked in this order over a substrate 10. The negative electrode side current collector film 70 has a negative electrode inside current collector film 70a and a negative electrode outside current collector film 70b. The negative electrode inside current collector film 70a is disposed on the side close to the solid electrolyte film 50 in the thickness direction, while the negative electrode outside current collector film 70b is disposed on the side remote from the solid electrolyte film 50 in the thickness direction.

The substrate 10, the positive electrode current collector film 30, the positive electrode active material film 40, the solid electrolyte film 50, the negative electrode side current collector film 70 (the negative electrode inside current collector film 70a and the negative electrode outside current collector film 70b) and the protective film 80 are the same as those in the first embodiment above, and, therefore, detailed descriptions of them are omitted. Hereafter, the negative electrode side current collector protection film 66 will be described.

{Negative Electrode Side Current Collector Protection Film}

It suffices for the material constituting the negative electrode side current collector protection film 66 to be a material which ensures easy occlusion and release of lithium ions therein and therefrom and which permits a large amount of lithium ions to be occluded therein and released therefrom. Examples of the material usable here include oxides of any of Sn, Si, Al, Ge, Sb, Ag, Ga, In, Fe, Co, Ni, Ti, Mn, Ca, Ba, La, Zr, Ce, Cu, Mg, Sr, Cr, Mo, Nb, V, Zn, etc. Besides, mixtures of two or more of these oxides can also be used.

Specific examples of the usable material include silicon-manganese alloy (Si—Mn), silicon-cobalt alloy (Si—Co), silicon-nickel alloys (Si—Ni), niobium pentoxide (Nb₂O₅), vanadium pentoxide (V₂O₅), titanium oxide (TiO₂), indium oxide (In₂O₃), zinc oxide (ZnO), tin oxide (SnO₂), nickel oxide (NiO), Sn-added indium oxide (ITO), Al-added zinc oxide (AZO), Ga-added zinc oxide (GZO), Sn-added tin oxide (ATO), and F (fluorine)-added tin oxide (FTO). Besides, mixtures of two or more of these oxides can also be used.

In the case of forming the negative electrode side current collector protection film 66, for example, the thickness of the film is so selected that it is sufficiently smaller than the thickness of the positive electrode active material film and that, when the negative electrode side current collector protection film 66 is deemed as a negative electrode active material, the theoretical Li-containing capacity thereof is not more than one half the theoretical Li-containing capacity of the positive electrode active material layer. In an initial stage of charging of the cell, a portion of the negative electrode side current collector protection film 66 behaves as a negative electrode active material. However, the negative electrode side current collector protection film 66 immediately is fully charged, and, thereafter, the Li excess layer is generated. Besides, in the charging and discharging thereafter, only the repeated generation and losing (extinction or disappearance) of the Li excess layer are utilized. Accordingly, in this solid electrolyte cell, the Li excess layer functions essentially as the negative electrode active material.

The negative electrode side current collector protection film 66 takes in Li during initial charging of the cell, but the Li content is maintained at a fixed level during the charging and discharging process thereafter. In addition, diffusion of Li into the negative electrode side current collector film 70 is thereby restrained, and deterioration of the negative electrode side current collector film 70 is suppressed. As a result, repeated charge-discharge characteristics are made extremely favorable, and, further, loss of charging capacity due to diffusion of Li into the negative electrode side current collector film 70 is minimized. If the negative electrode side current collector protection film 66 is absent, Li would diffuse into the negative electrode side current collector film 70. Therefore, the total amount of Li attendant on the charging and discharging of the cell cannot be kept constant. Consequently, charge-discharge characteristics would be deteriorated.

Incidentally, the thickness of the Li excess layer formed at the interface on the negative electrode side of the solid electrolyte film varies correspondingly to the thickness of the positive electrode active material film 40. However, it suffices for the negative electrode side current collector protection film 66 to function sufficiently as a protective film for the Li excess layer formed at the interface on the negative electrode side of the solid electrolyte film 50. Therefore, the thickness of the negative electrode side current collector protection film 66 has no direct relation with the thickness of the Li excess layer, and does not depend on the thickness of the positive electrode active material film 40.

In the case where the capacity of the negative electrode active material is less than the amount of Li in the positive electrode active material, that portion of Li which cannot be accepted into the negative electrode active material is precipitated at the interface, to form the Li excess layer, and the Li excess layer functions as the negative electrode active material. This process is utilized in the present solid electrolyte cell. In this solid electrolyte cell, the thickness of the negative electrode side current collector protection film 66 is set to be sufficiently thinner than the positive electrode active material film 40, whereby it is ensured that the negative electrode active material is essentially absent in the non-charged state.

The negative electrode side current collector protection film 66 in this solid electrolyte cell may be formed of a material which is utilized as a negative electrode active material. In this case, therefore, more accurately speaking, a portion of the negative electrode side current collector protection film 66 functions as the negative electrode active material, while the remainder functions as a protective film for the Li excess layer. In the case where the thickness of the negative electrode side current collector protection film 66 is sufficiently smaller than the thickness of the positive electrode active material layer 40, the negative electrode side current collector protection film 66 is mostly used as the protective film.

In this solid electrolyte cell, the negative electrode side current collector protection film 66 is formed to be sufficiently thinner as compared with the thickness of the positive electrode active material film 40, whereby it is ensured that the Li excess layer precipitated at the interface and functioning as the negative electrode active material is in charge of not less than one half the driving of the cell.

{Method of Manufacturing Solid Electrolyte Cell}

The solid electrolyte cell as above-described can be manufactured, for example, as follows. First, the positive electrode side current collector film 30, the positive electrode active material film 40, the solid electrolyte film 50, the negative electrode side current collector protection film 66, the negative electrode inside current collector film 70a, the negative electrode outside current collector film 70b, and the protective film 80 are sequentially formed over the substrate 10. By this process, the solid electrolyte cell according to the second embodiment can be manufactured.

3. Third Embodiment

A solid electrolyte cell according to a third embodiment will now be described. FIG. 3 is a sectional view showing the configuration of the solid electrolyte cell according to the third embodiment. This solid electrolyte cell is, for example, a thin-film type solid electrolyte cell in which cell component members have thin films.

As shown in FIG. 3, this solid electrolyte cell includes a positive electrode side current collector film 30, a positive electrode active material film 40, a solid electrolyte film 50, a negative electrode active material film 68, a negative electrode side current collector film 70, and a protective film 80 which are stacked in this order over a substrate 10. The negative electrode side current collector film 70 has a negative electrode inside current collector film 70a and a negative electrode outside current collector film 70b. The negative electrode inside current collector film 70a is disposed on the side close to the solid electrolyte film 50 in the thickness direction, while the negative electrode outside current collector film 70b is disposed on the side remote from the solid electrolyte film 50 in the thickness direction.

The substrate 10, the positive electrode side current collector film 30, the positive electrode active material film 40, the solid electrolyte film 50, the negative electrode side current collector film 70 (the negative electrode inside current collector film 70a and the negative electrode outside current collector film 70b), and the protective film 80 are the same as those in the first embodiment above, and, therefore, detailed descriptions of them are omitted. Hereafter, the negative electrode active material film 68 will be described.

{Negative Electrode Active Material Film}

As the material constituting the negative electrode active material film 68, there can be used lithium metal, lithium alloys and the like. Besides, as the material constituting the negative electrode active material film 68, there can also be used those materials which ensure easy occlusion and release of lithium ions therein and therefrom and which permits a large amount of lithium ions to be occluded therein and released therefrom. Examples of such a material include oxides of any of Sn, Si, Al, Ge, Sb, Ag, Ga, In, Fe, Co, Ni, Ti, Mn, Ca, Ba, La, Zr, Ce, Cu, Mg, Sr, Cr, Mo, Nb, V, Zn, etc. Besides, mixtures of two or more of these oxides can also be used.

Specific examples of the usable material here include silicon-manganese alloy (Si—Mn), silicon-cobalt alloy (Si—Co), silicon-nickel alloy (Si—Ni), niobium pentoxide (Nb₂O₅), vanadium pentoxide (V₂O₅), titanium oxide (TiO₂), indium oxide (In₂O₃), zinc oxide (ZnO), tin oxide (SnO₂), nickel oxide (NiO), Sn-added indium oxide (ITO), Al-added zinc oxide (AZO), Ga-added zinc oxide (GZO), Sn-added tin oxide (ATO), and F (fluorine)-added tin oxide (FTO). Besides, mixtures of two or more of these can also be used.

{Method of Manufacturing Solid Electrolyte Cell}

The solid electrolyte cell as above-described can be manufactured, for example, as follows. First, the positive electrode side current collector film 30, the positive electrode active material film 40, the solid electrolyte film 50, the negative electrode active material film 68, the negative electrode inside current collector film 70a, the negative electrode outside current collector film 70b, and the protective film 80 are sequentially formed over the substrate 10. By this process, the solid electrolyte cell according to the third embodiment can be manufactured.

[Examples]

Now, the present will be specifically described by showing Examples, but the present is not to be limited only to the Examples.

<Example 1>

A thin-film solid lithium ion secondary cell with a negative electrode side current collector film having a two-layer structure as shown in FIG. 1 was produced by the following method.

A positive electrode side current collector film, a positive electrode active material film, a solid electrolyte film, a negative electrode potential forming film, and a negative electrode side current collector film (a negative electrode inside current collector film and a negative electrode outside current collector film) were sequentially formed over a polycarbonate substrate by sputtering. Incidentally, the sputtering was carried out using a 500-μm stainless steel mask. It is to be noted here, however, that pattern formation can be carried out using lithographic technique.

Specifically, a film of Ti as the positive electrode side current collector film was formed in a thickness of 100 nm, a film of LiCoO₂ as the positive electrode active material film was formed in a thickness of 200 nm, a film of Li₃PO₄₋ₓNₓ as the solid electrolyte film was formed in a thickness of 500 nm, a film of LiCoO₂ as the negative electrode potential forming film was formed in a thickness of 10 nm, a film of Cu as the negative electrode inside current collector film was formed in a thickness of 5 nm, and a film of Al as the negative electrode outside current collector film was formed in a thickness of 5 nm.

These thin films were formed under the following conditions. Incidentally, the sputtering time was appropriately controlled so that a desired film thickness could be obtained. A sputtering apparatus SMO-01 special type (made by ULVAC, Inc.) was used for the sputtering.

{Positive Electrode Side Current Collector Film}

Target composition: Ti

Sputtering gas: Ar 70 sccm, 0.45 Pa

Sputtering power: 1,000 W (DC)

{Positive Electrode Active Material Film}

Target composition: LiCoO₂

Sputtering gas: (Ar 80%+O2 20% mixed gas), 20 sccm, 0.20 Pa

Sputtering power: 300 W (RF)

{Solid Electrolyte Film}

Target composition: Li₃PO₄

Sputtering gas: Ar 20 sccm+N2 20 sccm, 0.26 Pa

Sputtering power: 600 W (RF)

{Negative Electrode Potential Forming Film}

Target composition: LiCoO₂

Sputtering gas: (Ar 80%+O2 20%, mixed gas) 20 sccm, 0.20 Pa

Sputtering power: 300 W (RF)

[Negative electrode side current collector film]

{Negative electrode inside current collector film}

Target composition: Cu

Sputtering gas: Ar 70 sccm, 0.45 Pa

Sputtering power: 500 W (DC)

{Negative electrode outside current collector film}

Target composition: Al

Sputtering gas: Ar 70 sccm, 0.45 Pa

Sputtering power: 1,000 W (DC)

<Example 2>

The negative electrode inside current collector film was formed under the following conditions.

{Negative electrode inside current collector film}

Target composition: Ni

Sputtering gas: Ar 70 sccm, 0.45 Pa

Sputtering power: 1,000 W (DC)

A thin-film solid lithium ion secondary cell was produced in the same manner as in Example 1, except for the just-mentioned points.

<Example 3>

A thin-film solid lithium ion secondary cell was produced in the same manner as in Example 1, except that the thickness of the negative electrode inside current collector film was changed to 10 nm.

<Example 4>

A thin-film solid lithium ion secondary cell was produced in the same manner as in Example 1, except that the thickness of the negative electrode inside current collector film was changed to 20 nm.

<Example 5>

A thin-film solid lithium ion secondary cell was produced in the same manner as in Example 1, except that the thickness of the negative electrode outside current collector film was changed to 10 nm.

<Example 6>

A thin-film solid lithium ion secondary cell was produced in the same manner as in Example 1, except that the thickness of the negative electrode outside current collector film was changed to 20 nm.

<Example 7>

A thin-film solid lithium ion secondary cell was produced in the same manner as in Example 1, except that the thickness of the negative electrode inside current collector film was changed to 95 nm.

<Example 8>

A thin-film solid lithium ion secondary cell was produced in the same manner as in Example 1, except that the thickness of the negative electrode inside current collector film was changed to 145 nm.

<Example 9>

A thin-film solid lithium ion secondary cell was produced in the same manner as in Example 1, except that the thickness of the negative electrode outside current collector film was changed to 95 nm.

<Example 10>

A thin-film solid lithium ion secondary cell was produced in the same manner as in Example 1, except that the thickness of the negative electrode outside current collector film was changed to 145 nm.

<Example 11>

A positive electrode active material film and a negative electrode potential forming film were formed in the following conditions.

{Positive electrode active material film}

Target composition: LiMn₂O₄

Sputtering gas: (Ar 80%+O₂ 20%), 20 sccm

Sputtering power: 300 W

Film thickness: 120 nm

{Negative electrode potential forming film}

Target composition: LiMn₂O₄

Sputtering gas: (Ar 80%+O₂ 20%), 20 sccm

Sputtering power: 300 W

Film thickness: 5 nm

A thin-film solid lithium ion secondary cell was produced in the same manner as in Example 1, except for the just-mentioned points.

<Example 12>

A thin-film solid lithium ion secondary cell was produced in the same manner as in Example 11, except that the negative electrode potential forming film was omitted.

<Comparative Example 1>

A thin-film solid lithium ion secondary cell with a negative electrode side current collector film having a monolayer structure was produced. To be more specific, a thin-film solid lithium ion secondary cell was produced in the same manner as in Example 1, except that the negative electrode side current collector film was formed in the following conditions.

{Negative electrode side current collector film}

Target composition: Al

Sputtering gas: Ar 70 sccm, 0.45 Pa

Sputtering power: 1,000 W (DC)

Film thickness: 10 nm

<Comparative Example 2>

A thin-film solid lithium ion secondary cell with a negative electrode side current collector film having a monolayer structure was produced. Specifically, a thin-film solid lithium ion secondary cell was produced in the same manner as in Example 1, except that the negative electrode side current collector film was formed under the following conditions.

{Negative electrode side current collector film}

Target composition: Al

Sputtering gas: Ar 70 sccm, 0.45 Pa

Sputtering power: 1,000 W (DC)

Film thickness: 5 nm

<Comparative Example 3>

A thin-film solid lithium ion secondary cell with a negative electrode side current collector film having a monolayer structure was produced. To be more specific, a thin-film solid lithium ion secondary cell was produced in the same manner as in Example 1, except that the negative electrode side current collector film was formed in the following conditions.

{Negative electrode side current collector film}

Target composition: Cu

Sputtering gas: Ar 70 sccm, 0.45 Pa

Sputtering power: 500 W (DC)

Film thickness: 5 nm

{Measurement of charge-discharge characteristics}

For each of the thin-film solid lithium ion secondary cells obtained in Examples 1-10 and Comparative Examples 1-3, capacity retention after 50 cycles was determined in the following manner.

Each of the cells produced as above was put to measurement of charge-discharge characteristics. A charge-discharge cycle was repeated 50 times. As for the charging and discharging conditions, a constant-current constant-voltage charging at 60 μA and 4.1 V was conducted with a finishing condition of 15 μA, and a constant-current discharging at 6 μA was carried out with a finishing condition of 1.0 V. Then, the proportion (percentage) of the discharging capacity at 50th cycle based on the discharging capacity at the first cycle was determined as capacity retention after 50 cycles.

{Evaluation}

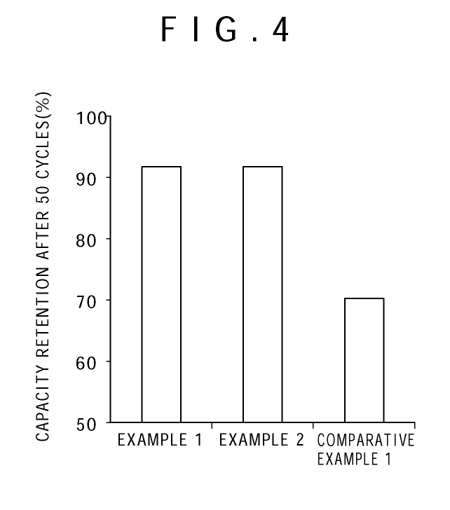

Column charts of capacity retention after 50 cycles for Example 1, Examples 2 and Comparative Example 1 are shown in FIG. 4.

As shown in FIG. 4, in Example 1 and Example 2, in which the negative electrode side current collector film was composed of two layers including the negative electrode inside current collector film (Cu film or Ni film) and the negative electrode outside current collector film (Al film), a capacity retention of not less than 90% was exhibited after 50 cycles. On the other hand, in Comparative Example 1, in which the negative electrode side current collector film was a monolayer film (Al film), a capacity retention after 50 cycles was about 70%. From these results it was verified that excellent cycle characteristics can be obtained when the negative electrode side current collector film is composed of two layers including a negative electrode inside current collector film (Cu film or Ni film) and a negative electrode outside current collector film (Al film).

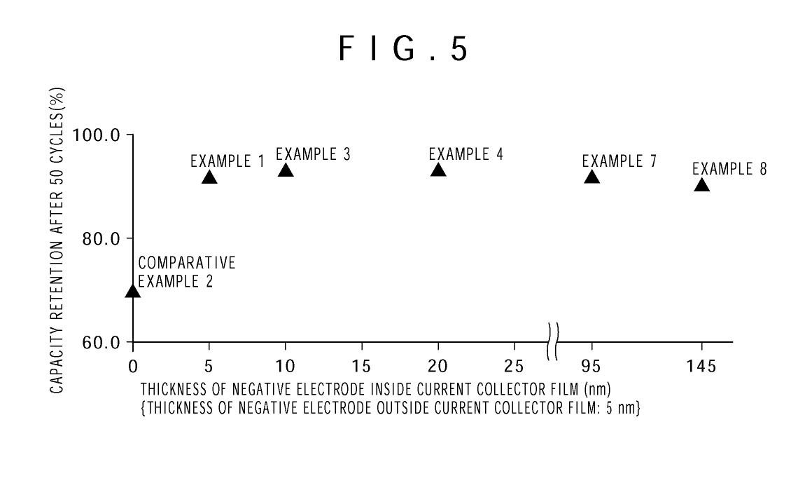

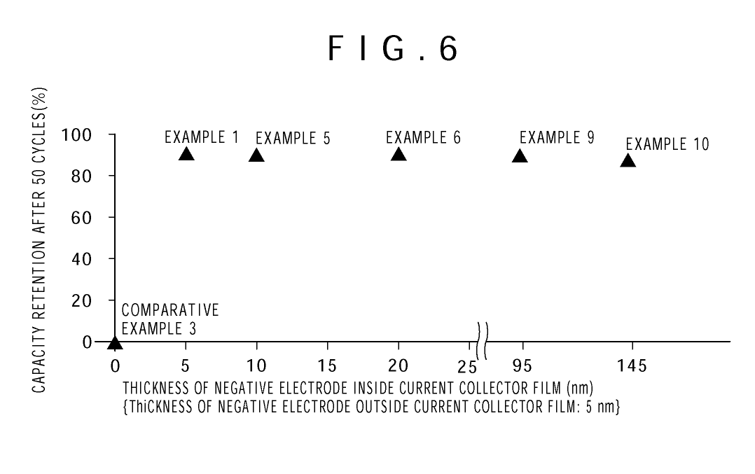

A graph showing capacity retention after 50 cycles plotted against the thickness of the negative electrode side current collector film, for each of Examples 1, 3, 4, 7 and 8 and Comparative Example 2, is shown in FIG. 5. Besides, a graph showing capacity retention after 50 cycles plotted against the thickness of the negative electrode side current collector film, for each of Examples 1, 5, 6, 9 and 10 and Comparative Example 3, is shown in FIG. 6.

As shown in FIGS. 5 and 6, it was verified that more excellent cycle characteristics can be obtained when the total thickness of the negative electrode side current collector film composed of two layers is not less than 10 nm. Incidentally, in Example 1, the negative electrode potential forming film (LiCoO₂ film) was 10 nm in thickness and its film formation rate was 0.025 nm/sec (300 W), whereas the Al metal film formation rate was 0.25 nm/sec (300 W) (in the case where a target of the same size and the same film forming machine as in formation of the negative electrode potential forming film were used). Thus, during the tact for forming the negative electrode potential forming film (LiCoO₂ film) in a thickness of 10 nm, the Al film can be formed in a thickness of 100 nm. Therefore, when the thickness of the Al film is more than 100 nm, the Al film formation serves as the rate-determining process for the production tact. Accordingly, the thickness of the Al film is preferably not more than 100 nm.

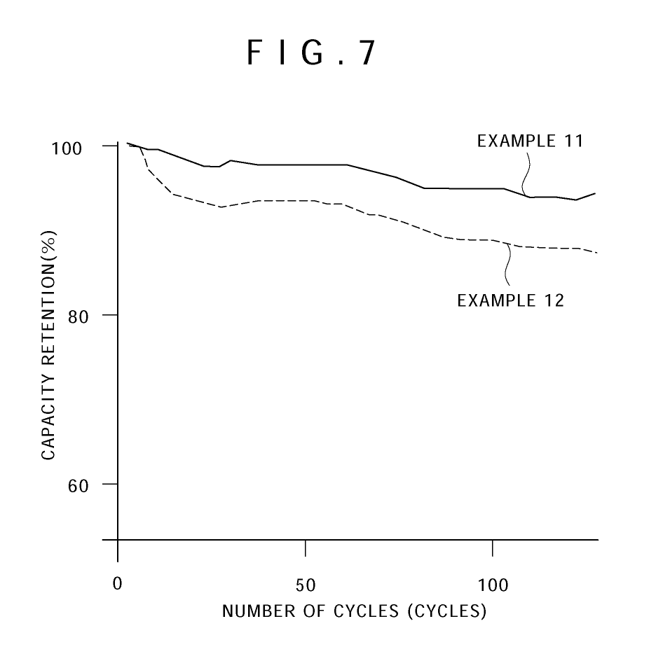

For each of Example 11 and Example 12, charging and discharging were repeated under the same conditions as in the measurement of charge-discharge characteristics above, so as to evaluate cycle characteristics. FIG. 7 shows a graph of capacity retention plotted against the number of charge-discharge cycles.

As shown in FIG. 7, it was verified that in Example 11 in which the negative electrode potential forming film was formed, better cycle characteristics could be obtained, as compared with Example 12 in which the negative electrode potential forming film was not formed. This can be interpreted as follows. Formation of the negative electrode potential forming film can restrain the diffusion of Li into the negative electrode side current collector film, whereby deterioration of the negative electrode current collector film can be suppressed, and much enhanced cycle characteristics can be obtained.

4. Other Embodiments

The present is not to be limited to the above-described embodiments, and various modifications and applications are possible within the scope. For instance, the cell may have a film configuration of the substrate 10/negative electrode outside current collector film 70b/negative electrode inside current collector film 70a/negative electrode potential forming film 64/solid electrolyte film 50/positive electrode active material film 40/positive electrode side current collector film 30/protective film 80. In addition, for example in the case where the thickness of the negative electrode side current collector film 70 is not more than 150 nm, titanium (Ti) may be used as the material constituting the negative electrode outside current collector film 70b. Besides, for example, a structure may be adopted in which a conductive material is used as the substrate 10 and in which the positive electrode side current collector film 30 is omitted. Furthermore, for example, a metallic plate formed of a positive electrode side current collector material may be used to constitute the positive electrode side current collector film 30.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A solid electrolyte cell comprising:
a positive electrode side layer;
a negative electrode side layer; and
a solid electrolyte layer disposed between the positive electrode side layer and the negative electrode side layer,
wherein the negative electrode side layer includes a negative electrode side current collector layer,
the negative electrode side current collector layer includes a first negative electrode side current collector layer disposed on a side close to the solid electrolyte layer, and a second negative electrode side current collector layer disposed on a side remote from the solid electrolyte layer,
the first negative electrode side current collector layer includes copper, nickel, or an alloy containing any of copper and nickel, or stainless steel, and
the second negative electrode side current collector layer includes aluminum, silver, or an alloy containing any of aluminum and silver.

2. The solid electrolyte cell according to claim 1, wherein a lithium excess layer is formed at an interface on the negative electrode side of the solid electrolyte layer at the time of charging.

3. The solid electrolyte cell according to claim 2, wherein the negative electrode side layer further includes a negative electrode potential forming layer disposed between the first negative electrode side current collector layer and the solid electrolyte layer.

4. The solid electrolyte cell according to claim 3, wherein the negative electrode potential forming layer contains a material which is the same as a positive electrode active material or a material which is comparable to the positive electrode active material in potential.

5. The solid electrolyte cell according to claim 4, wherein the positive electrode active material contains a lithium composite oxide having Li together with Co or Mn.

6. The solid electrolyte cell according to claim 1, wherein the negative electrode side layer includes a negative electrode active material layer disposed between the first negative electrode side current collector layer and the solid electrolyte layer.

7. The solid electrolyte cell according to claim 1, wherein at least any of the layers constituting the positive electrode side layer, the layers constituting the negative electrode side layer, and the solid electrolyte layer has a thin film.

8. The solid electrolyte cell according to claim 1, wherein the thickness of the negative electrode side current collector layer is not less than 10 nm.

9. The solid electrolyte cell according to claim 8, wherein the thickness of the negative electrode side current collector layer is not more than 150 nm.
